(19) United States
(12) Patent Application Publication
(10) Pub. No.: US 2012/0174629 A1
(43) Pub. Date: Jul. 12, 2012

(54) METHOD AND DEVICE FOR DRAWING A QUARTZ GLASS CYLINDER FROM A MELT CRUCIBLE

(75) Inventors: Helmut Leber, Hanau (DE); Rainer Berg, Langenselbold (DE); Nigel Whippey, Seligenstadt (DE)

(73) Assignee: HERAEUS QUARZGLAS GMBH & CO. KG, Hanau (DE)

(21) Appl. No.: 13/381,050

(22) PCT Filed: Jun. 15, 2010
(86) PCT No.: PCT/EP2010/058359

§ 371 Date: Mar. 20, 2012

(30) Foreign Application Priority Data
Jun. 26, 2009 (DE) 10 2009 030 852.0

(51) Int. Cl. C03B 17/04

(52) U.S. Cl. 65/66; 65/187

(57) ABSTRACT

The invention relates to a known method for drawing a quartz glass cylinder from a melt crucible comprising an inner crucible chamber extending in the direction of a center crucible axis and bounded by a side wall and a floor, wherein SiO₂ granulate is fed into the melt crucible and therein softened into a quartz glass mass, and said mass is drawn vertically downward as a cylindrical quartz glass strand by means of a first draw-off device through a first draw nozzle provided in the floor of the melt crucible, and the quartz glass cylinder is cut off therefrom. In order to disclose a method starting herefrom and allowing the production of homogenous quartz glass cylinder at simultaneously high levels of productivity, the invention proposes that at least one second quartz glass strand is drawn off through at least one further second draw nozzle provided in the floor of the melt crucible, wherein the first draw nozzle and the second draw nozzle are disposed eccentrically to the center crucible axis and at a distance from each other.

The present invention relates to a method for drawing a quartz glass cylinder from a melting crucible comprising a crucible interior which extends in the direction of a central axis of the crucible and is defined by a side wall and a bottom, in that SiO₂ granules are fed to the melting crucible and are softened therein to form a viscous quartz glass mass, and said mass is drawn off vertically downwards as a cylindrical strand of quartz glass by means of a first draw-off device through a first drawing nozzle provided in the bottom of the melting crucible, and the quartz glass cylinder is cut off therefrom.

Furthermore, the present invention relates to a device for drawing a quartz glass cylinder, comprising a melting crucible used for accommodating SiO₂ granules, which comprises a crucible interior which extends in a direction of a central axis of the crucible and is defined by a side wall and a bottom, comprising a heating device for softening the SiO₂ granules, and a first drawing nozzle provided in the bottom of the melting crucible, and a first draw-off device for drawing off a quartz glass strand through the first drawing nozzle.

### PRIOR ART

Vertical-type crucible drawing methods are used for continuously producing cylindrical components of quartz glass, such as rods, tubes or plates of any desired cross-sectional profile. SiO₂ granules are here molten as a glass start material in a melting crucible to obtain a quartz glass mass of relatively high viscosity (hereinafter also called “quartz glass melt”) and are drawn off via an axially symmetrical drawing nozzle, which is designed for the target product, on the crucible bottom as a glass strand. The glass strand is cut to length to obtain sections from which the desired quartz glass component is manufactured as a finished product or as a semifinished product.

Particular attention is here paid that inhomogeneities in the drawn-off glass strand are avoided and that melting conditions which are as uniform and constant as possible are created in the crucible interior. Due to its high temperature and viscosity a quartz glass melt can however not be homogenized by means of the techniques as are standard in low-viscosity glass melts, such as borosilicate glass melts or soda-lime glass melts. In particular, stirring devices used for refining such glass melts are not suited for homogenizing a quartz glass melt because bubbles created during stirring can no longer be eliminated due to the high viscosity in the course of the drawing process.

A hopper which projects into the melting crucible and the lower end of which ends above the surface of the viscous quartz glass mass is normally provided for the supply of the SiO₂ granules. A conical heap is here formed from the grainy SiO₂ raw material which is floating on the melt surface. These drawing methods are characterized by a flow behavior of the quartz glass melt with a significantly higher flow rate in the region of the central axis of the melting crucible than in the edge portion, which flow could also be called “silo flow”.

The SiO₂ grain particles along the direct connection line between the conical heap center and the drawing nozzle of the melting crucible are here subjected to a comparatively short holding time in the melt and thus to a correspondingly small temperature load. This effect is even intensified in that the axial temperature profile along the central axis of the crucible has temperatures up to 50° C. lower than the temperatures on the edge, which might even have the consequence that SiO₂ granules in the crucible center are not fully fused and lead to defects in the drawn-off glass strand.

The “silo flow” is unfavorably noticed, especially in cases where the drawing nozzle is small-sized, and requires, on the whole, an extension of the mean holding times for the SiO₂ granules, thereby limiting the efficiency of the melt throughput.

Attempts have therefore been made to achieve a fusion of the glass start substances that is as uniform as possible with the help of a particularly adapted axial temperature curve in the drawing furnace (DE 22 5 725 B) or identical and constant fusion conditions through a reproducible distribution and compaction of the SiO₂ granules to be fused on the melt surface (U.S. Pat. No. 3,249,417 A; WO 2006/015763 A).

It has also been suggested that the flows of the viscous quartz-glass melt should be guided for the purpose of homogenizing the temperature. A method of this type is described in DE 1 596 664 A. which also discloses a device of the aforementioned type. For drawing a tubular quartz-glass strand from a melting crucible a tungsten nozzle is used that forms a circular opening into which a mandrel projects from above that is held suspended from a hollow shaft of tungsten in the quartz glass melt. The position of the mandrel is variable. The mandrel comprises an upper part with a bulge in the form of an hourglass that is connected via an intermediate ring to a frustoconical lower part that extends up and into the nozzle opening while leaving an annular gap of variable width. Due to the geometry of the upper part the central and colder melt flows are deflected, whereby the temperature is homogenized within the quartz glass melt.

The device used in the known drawing method is relatively complicated in terms of design and handling, and the method turns out to be comparatively sensitive to temperature variations in the crucible interior.

### TECHNICAL OBJECT

It is therefore the object of the present invention to provide a method which permits the manufacture of homogeneous quartz glass cylinders together with high productivity.

Furthermore, it is the object of the present invention to provide a device of simple design that is easy to handle for performing the method.

As for the method. this object starting from the aforementioned method is achieved according to the invention in that at least one second strand of quartz glass is drawn off through at least one further, second drawing nozzle provided in the bottom of the melting crucible, the first drawing nozzle and the second drawing nozzle being spaced apart from each other and being eccentrically arranged relative to the central axis of the crucible.

It is the objective of the invention to avoid a pronounced silo flow in the crucible center, accompanied by a direct entry of hardly homogenized quartz glass mass into the drawing nozzle, and to enhance the productivity of the drawing method at the same time. For this purpose the cooperation of several measures is decisive:
1. Instead of only one single drawing nozzle, two or more drawing nozzles through which a quartz glass strand is respectively drawn off from the melting crucible are provided in the bottom of the melting crucible. It is evident that this measure enhances the productivity of the drawing method.
2. However, it is here also important that none of the drawing nozzles is exactly arranged in the center of the crucible. The eccentric arrangement of the drawing nozzles avoids or reduces the central flow, which is unfavorable under technical melting aspects, and leads to a flow that is rather closer to the edge. This simultaneously yields an axial temperature profile with temperatures that are higher on average in comparison with the axial temperature profile in the central axis of the crucible. This permits a reduction of the melting energy to be supplied, which in turn saves energy and particularly avoids thermal loads on the melting crucible and thereby counteracts the introduction of contaminations into the melt
3. The at least two drawing nozzles produce individual flows that are partly coupled with and act on each other. This results in a certain blending effect which contributes to a homogenization of the quartz glass mass.

Depending on the number of the drawing nozzles, one achieves—with the same product-specific standard melting power—an increase in the holding time in the melting crucible and together with this a higher quality of the drawn-off quartz glass, and vice versa, if the specific holding times that have so far been customary are observed, one will achieve an assignable increase in the melting power.

Hence, the invention not only directly enables an increase in productivity as compared with the conventional drawing method, but at the same time it is possible to improve the homogeneity of the drawn-off quartz glass strand at a constant crucible temperature or to decrease the temperature load on the melting crucible at a constant homogeneity. These measures have also an indirect effect on productivity, as has been explained above.

The positive effects of the measures explained above under 2. and 3. depend on the local distribution of the drawing nozzles over the crucible bottom and here particularly on the distance of the drawing nozzles from one another. These effects are in a first approximation the more pronounced the greater the distance between the drawing nozzles is. With respect to this, it has turned out to be advantageous when the first drawing nozzle and the further second drawing nozzle are spaced apart from each other at a distance of at least 20 mm, preferably at least 50 mm.

Distance does here not mean the distance of the central axes of neighboring drawing nozzles, but the smallest distance of the respective nozzle openings. Hence, the distance describes the minimum web width in the crucible bottom that remains between the nozzle openings.

The eccentric arrangement of the drawing nozzles relative to the central axis of the crucible also includes a procedure in which one of the drawing nozzle openings intersects the central axis of the crucible. In a particularly preferred procedure, however, it is intended that the drawing nozzles are arranged to be uniformly distributed around the central axis of the melting crucible.

None of the drawing nozzle openings intersects the central axis of the melting crucible, so that the central flow is predominantly avoided. The uniform distribution of the drawing nozzles around the central axis of the melting crucible contributes to a reproducible and uniform distribution of the fused quartz glass mass in the respective quartz glass strands.

In this connection it has also turned out to be advantageous when exactly two drawing nozzles are provided which are opposite each other at the central axis of the crucible.

It has been found that in the presence of more than two drawing nozzles the constructional efforts, particularly for the controlled drawing off of the respective quartz glass strands, are disproportionally increasing. In the preferred procedure only two drawing nozzles are therefore provided. Their drawing nozzle openings are opposite at the central axis of the crucible, but they do not intersect the central axis. For the reason already explained above (uniform distribution of the molten quartz glass mass) the drawing nozzle openings preferably have the same distance from the central axis.

A procedure is preferred in which a quartz glass strand is drawn off through the first drawing nozzle with a first mass flow, and in which a quartz glass strand is drawn off through the second drawing nozzle with a second mass flow, said first and second mass flows differing by not more than 100% (based on the smaller one of the mass flows) from each other.

When the mass flows drawn out from the drawing nozzles differ to a very great degree, it may happen that due to the reaction of the respective flows within the melting crucible a minor change in the stronger flow (and the greater mass flow) leads to an unintentionally significant change in the weaker flow (and the smaller mass flow) and has a disadvantageous effect on product quality.

Especially with respect to a distribution of the opening cross-sections of the drawing nozzles that is as uniform as possible, with respect to a mutual influencing that is as insignificant as possible and with respect to an impact that is as small as possible upon interruption or change in the drawing off of one of the quartz glass strands, the mass flows are as small as possible. It has turned out to be advantageous when the opening cross-section of first and second drawing nozzle is not more than 50 cm² each time.

In a constructionally particularly simple special case the draw-off device is provided for drawing off a plurality of quartz glass strands from the drawing nozzles at the same time. This, however, presupposes the same geometry of the drawing nozzle openings and the drawn-off quartz glass strands.

A greater variability in the use of drawing nozzles of different cross-sectional geometries and in the profile and the radial dimension of the drawn-off quartz glass strands will be achieved if a second draw-off device is used for drawing off the quartz glass strand exiting from the second drawing nozzle.

The two quartz glass strands can here be drawn off independently and adjusted to their desired dimensions.

Preferably, the first draw-off device comprises a first roll-type dragger extending over a first extension section along the central axis of the crucible, and the second draw-off device comprises a second roll-type dragger extending over a second extension section along the central axis of the crucible such that the extension sections of first and second roll-type draggers do not overlap.

A roll-type dragger comprises a plurality of dragger rolls distributed around the glass strand to be drawn off, which are opposite each other on the glass strand to be drawn off and exert a force on said glass strand that is suited for drawing off the glass strand. The drawing off in the form of a roll-type dragger enables a continuous drawing of the glass strand with comparatively small constructional efforts. For reasons of space it is therefore preferred that the roll-type draggers of the first and second draw-off device are arranged at different height levels.

As for the device, the above-indicated object starting from a drawing device of the aforementioned type is achieved according to the invention in that at least one further second drawing nozzle is provided in the bottom of the melting crucible. and that first drawing nozzle and second drawing nozzle are spaced apart from each other and eccentrically arranged relative to the central axis of the crucible.

It is the objective of the invention with respect to the device to avoid a pronounced silo flow in the crucible center with the help of simple constructional design means and to enhance the productivity of the drawing method at the same time. For this purpose the cooperation of several measures is decisive:
1. Instead of only one single drawing nozzle, two or more drawing nozzles through which a quartz glass strand is respectively drawn from the melting crucible are provided in the bottom of the melting crucible. The productivity of the drawing method is thereby enhanced.
2. None of the drawing nozzles is exactly arranged in the center of the crucible. The eccentric arrangement of the drawing nozzles avoids or reduces the central flow. which is unfavorable under technical melting aspects, and causes a flow which is rather closer to the edge. This simultaneously yields an axial temperature profile with temperatures that are higher on average as compared with the axial temperature profile in the central axis of the crucible. This saves not only energy due to a reduction of the melting energy needed, but also reduces the thermal loads on the melting crucible, which counteracts the introduction of contaminations into the melt and thus reduces material rejects; moreover, this prolongs the maintenance intervals and has thereby an advantageous effect on productivity on the whole.
3. The at least two drawing nozzles produce individual flows that are partly coupled with and act on each other. This results in a certain blending effect which contributes to a homogenization of the quartz glass mass and thus also to a reduction of material rejects.

Depending on the number of the drawing nozzles, with the same product-specific standard melting power one achieves an increase in the holding time in the melting crucible and together with this a higher quality of the drawn-off quart glass, and vice versa when the specific holding times that have so far been customary are observed, one achieves an assignable increase in the melting power.

Advantageous designs of the device according to the invention become apparent from the sub-claims. Insofar as the designs of the device indicated in the sub-claims copy the procedures indicated in sub-claims regarding the method according to the invention, reference is made to the above statements on the corresponding method claims for supplementary explanation.

### EMBODIMENT

The invention shall now be explained in more detail with reference to embodiments and a drawing which schematically shows in detail in

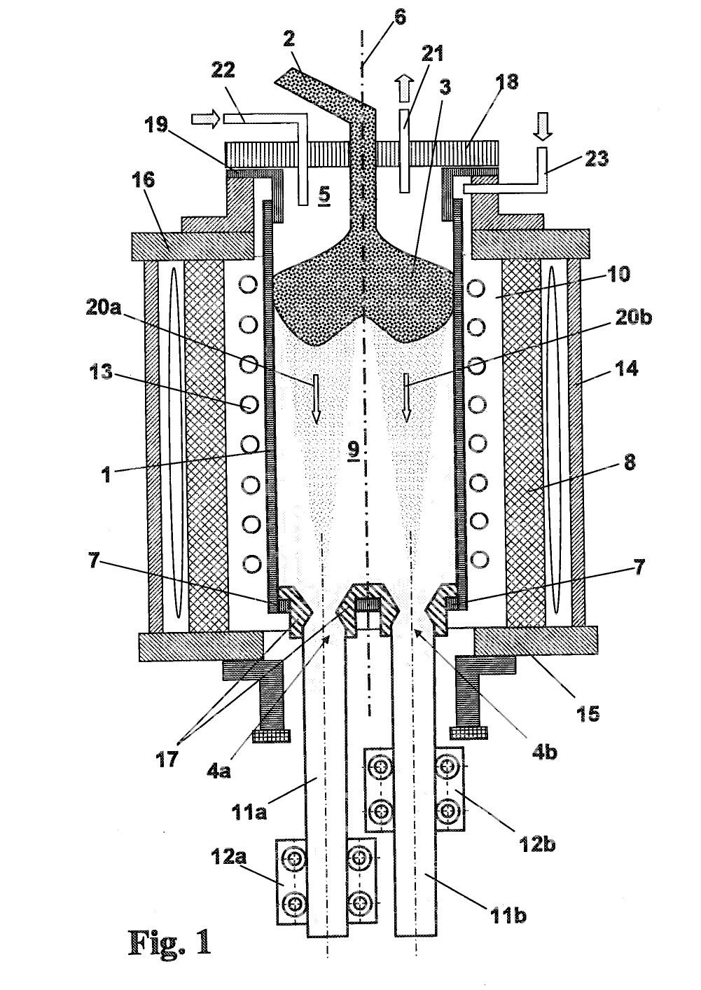

FIG. 1 an embodiment of a melting furnace according to the invention with a melting crucible having a plurality of drawing nozzles, in a side view and as a sectional illustration, and

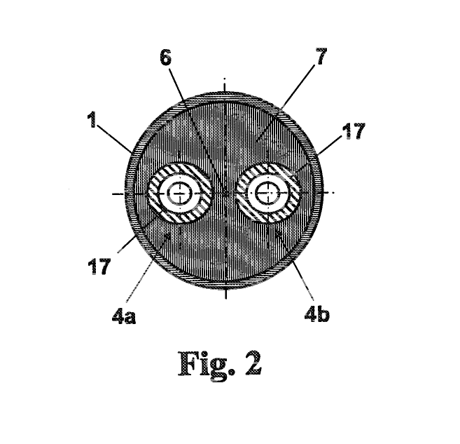

FIG. 2 a top view on the underside of the bottom of the melting crucible of FIG. 1.

The drawing nozzle of FIG. 1 comprises a melting crucible 1 of tungsten into which SiO₂ granules 3 are continuously fed from above via a feed pipe 2. The melting crucible 1 is surrounded by a water-cooled furnace jacket 14 with formation of a protective-gas chamber 10 flushed with protective gas, which accommodates a porous insulation layer 8 of oxidic insulation material and a resistance heater 13 for heating the SiO₂ granules 3. The protective gas chamber 10 is open downwards and otherwise sealed to the outside with a bottom plate 15 and with a top plate 16.

The melting crucible 1 encloses a cylindrical crucible interior 5 having an inner diameter of 40 mm, the longitudinal cylinder axis of which extends in a direction coaxial to the central axis 6 of the crucible. The crucible interior 5 is also sealed to the environment by means of a cover 18 and a sealing element 19. An inlet 22 and an outlet 21 for a crucible interior gas in the form of pure hydrogen project through the cover 18. The protective-gas chamber 10 is also provided in the upper portion with a gas inlet 23 for pure hydrogen.

Two drawing nozzles 4a and 4b that have a respective circular opening and also consist of tungsten components 17 are inserted into the bottom 7 of the melting crucible 1 eccentrically relative to the central axis 6. The drawing nozzles 4a, 4b are of the same construction and taper from the top to the bottom first to a minimum inner diameter of 40 mm before they expand again to 70 mm in the area of the lower nozzle opening.

Soft quartz-glass mass 9 exits via the drawing nozzles 4a, 4b and is drawn off vertically downwards in the direction of the central axis 6 of the melting crucible in the form of two solid-cylinder strands 11a, 11b, each having a diameter of 70 mm, by means of roll-type draggers 12a, 12b. The roll-type draggers 12a, 12b are arranged offset to each other over the height and are each connected to a control and regulation device (not shown in the figure) for regulating the diameter for the respective solid-cylinder strand 11a, 11b Sections of the desired length are cut to length from the two solid-cylinder strands.

For the sake of clarity like reference numerals and hatchings are used in the top view on the bottom side of the crucible bottom 7 in FIG. 2 for designating the same components as in FIG. 1 (although FIG. 2 shows no sectional representation). The drawing nozzles 4a and 4b tapering from the top to the bottom are eccentrically arranged and are opposite each other at a distance of 75 mm on the central line 6 of the crucible.

The method according to the invention will now be explained in more detail with reference to an embodiment and FIGS. 1 and 2.

### Example 1

SiO₂ granules 3 are continuously fed into the melting crucible 1 via the feed pipe 2 and heated therein to a temperature of about 2100° C. to 2200° C. A soft quartz glass mass 9 on which a grain layer of SiO₂ granules 3 is floating is thereby formed in the lower portion of the melting crucible 1. Two main mass flows 20a, 20b of the softened quartz-glass mass 9 of about the same size are formed starting from the SiO₂ granules 3 towards the two drawing nozzles 4a, 4b. These main mass flows 20a, 20b are illustrated in FIG. 1 by hatching and block arrows.

Since the quartz glass mass 9 in the near-edge portion of the melting crucible 1 is exposed to a temperature that is on average higher than that in the central portion, it is better homogenized in the two near-edge main mass flows than would be the case at the given crucible temperature in the central portion. A silo flow through the central melting crucible portion that includes the central line 6 of the crucible is thereby fully avoided and the productivity of the drawing method is doubled.

### Example 2

Alternatively, the SiO₂ granules 3 in the melting crucible 1 are heated to a temperature of about 2050° C. to 2150° C., i.e. approximately 50° C. less than in Example 1.

In this case, too, two near-edge main mass flows 20a, 20b of the quartz glass mass 9 that have about the same size are formed starting from the SiO₂ granules 3 towards the two drawing nozzles 4a, 4b.

The quartz glass mass 9 in the main mass flows 20a, 20b is here approximately exposed to a temperature load like the “silo flow” in a conventional drawing method, and the solid-cylinder strands 11a, 11b obtained thereby have about the same homogeneity as the central strand produced in the conventional drawing method. Since the temperature load on the crucible wall 1 and the crucible bottom 7 is however smaller, there will be a reduced input of abrasion from the crucible and of other impurities into the softened quartz glass mass and a longer service life of the melting crucible. The rejects are thus less and the maintenance interval is longer, which manifests itself in a higher productivity.

1. A method for drawing a quartz glass cylinder from a melting crucible having a crucible interior extending in a direction of a central axis of the crucible and defined by a side wall and a bottom, said method comprising:
feeding SiO₂ granules to the melting crucible and softening the SiO₂ granules therein so as to form a viscous quartz glass mass, and
drawing said mass off vertically downwards as a cylindrical strand of quartz glass with a first draw-off device through a first drawing nozzle provided in the bottom of the melting crucible, and
producing the quartz glass cylinder from said cylindrical strand by cutting off the quartz glass cylinder therefrom and
drawing a second strand of quartz glass off through a second drawing nozzle provided in the bottom of the melting crucible, the first drawing nozzle and the second drawing nozzle being spaced apart from each other and eccentrically arranged relative to the central axis of the crucible.

2. The method according to claim 1, wherein the first drawing nozzle and the second drawing nozzle are spaced apart from each other at a distance of at least 20 mm.

3. The method according to claim 1, wherein the drawing nozzles are supported uniformly distributed around the central axis of the crucible.

4. The method according to claim 1, wherein only the two drawing nozzles are provided and are supported opposite each other relative to the central axis of the crucible.

5. The method according to claim 4, wherein the first quartz glass strand is drawn off through the first drawing nozzle with a first mass flow, and the second quartz glass strand is drawn off through the second drawing nozzle with a second mass flow, said first and second mass flows differing by not more than 100% of a smaller one of the mass flows.

6. The method according to claim 1, wherein the first and second drawing nozzles have opening cross section of not more than 50 cm².

7. The method according to claim 1, wherein a second draw-off device draws off the second quartz glass strand exiting from the second drawing nozzle.

8. The method according to claim 5, wherein the first draw-off device comprises a first roll-type dragger extending over a first extension section along the central axis of the crucible, and wherein a second draw-off device draws off the second strand and comprises a second roll-type dragger extending over a second extension section along the central axis of the crucible such that the extension sections of first and second roll-type draggers do not overlap.

9. A device for drawing a quartz glass cylinder, said device comprising:
a melting crucible accommodating SiO₂ granules, said melting crucible having a cylindrical crucible interior extending in a direction of a central axis of the crucible and being defined by a side wall and a bottom, said melting crucible comprising a heating device softening the SiO₂ granules, and a first drawing nozzle provided in the bottom of the melting crucible, and
a first draw-off device drawing off a quartz glass strand through the first drawing nozzle, and
wherein a second drawing nozzle is provided in the bottom of the melting crucible, and
wherein the first drawing nozzle and the second drawing nozzle are spaced apart from each other and eccentrically arranged relative to the central axis of the crucible.

10. The device according to claim 9, wherein the first drawing nozzle and the second drawing nozzle are spaced apart from each other at a distance of at least 20 mm.

11. The device according to claim 9, wherein the drawing nozzles are uniformly distributed around the central axis of the crucible.

12. The device according to claim 9, wherein the crucible has no more than the two drawing nozzles provided opposite each other relative to the central axis of the crucible.

13. The device according to claim 9, wherein the first and second drawing nozzles each have an opening cross-section not more than 50 cm².

14. The device according to claim 9, wherein a second draw-off device draws off a smut quartz glass strand exiting from the second drawing nozzle.

15. The device according to claim 14, wherein the first draw-off device comprises a first roll-type dragger extending over a first extension section along the central axis of the crucible, and the second draw-off device comprises a second roll-type dragger extending over a second extension section along the central axis of the crucible such that the extension sections of first and second roll-type draggers do not overlap.

16. The method according to claim 1, wherein the first drawing nozzle and the second drawing nozzle are spaced apart from each other at a distance of at least 50 mm.

17. The device according to claim 9, wherein the first drawing nozzle and the second drawing nozzle are spaced apart from each other at a distance of at least 50 mm.
